(19) United States
(12) Patent Application Publication
(10) Pub. No.: US 2026/0221932 A1
(43) Pub. Date: Jul. 30, 2026

(54) AUTOMATIC SOLAR PANEL CLEANING SYSTEM

(71) Applicant: SAUDI ARABIAN OIL COMPANY, Dhahran (SA)

(72) Inventors: Abdullah Y. AL-HASSAN, Dhahran (SA); Mohammed T. BAQASI, Dhahran (SA); Ibrahim A. ALQARNI, Dhahran (SA)

(73) Assignee: SAUDI ARABIAN OIL COMPANY, Dhahran (SA)

(21) Appl. No.: 19/037,864

(22) Filed: Jan. 27, 2025

(51) Int. Cl. H02S 40/10; B08B 3/02; B08B 3/14; B08B 13/00; G05B 15/02

(52) U.S. Cl. CPC H02S 40/10; B08B 3/02; B08B 3/14; B08B 13/00; G05B 15/02

(57) ABSTRACT

An automatic solar panel cleaning system includes a solar panel, a sensor, a tank storing a cleaning fluid, a nozzle, a pump, and a controller. The sensor may include a light source emitting light at a face of the solar panel and a receiver configured to output a signal based on the amount of light detected by the receiver. The controller compares the signal that is output by the receiver to an accumulation threshold that is indicative of an undesired soil accumulation on the face of the solar panel. The controller then operates the pump after the signal reaches the accumulation threshold to pump the cleaning fluid from the tank and out of the nozzle onto the face of the solar panel to clean the face of the solar panel.

### FIELD OF THE DISCLOSURE

The present disclosure relates generally to solar panel maintenance and, more particularly, to automatically cleaning solar panels to maintain efficient operation of the solar panels.

### BACKGROUND OF THE DISCLOSURE

Solar panels include photovoltaic (PV) modules (e.g., solar cells) that produce electrical power in response to sunlight exposure. Solar panels are used to provide electrical power from solar energy in a wide range of industrial and residential applications, and in many applications solar panels are stationed in completely remote areas. Soil accumulation on a face of the solar panel adversely impacts the efficiency of the solar panel, causing the amount of electricity produced by the solar panel to decrease as the soil accumulation increases. Solar panels, therefore, require cleaning to maintain the solar panel efficiency.

Solar panels in remote areas are often subject to extreme environments (e.g., deserts) that promote soiling of the solar panels. Solar panels in remote areas are difficult to maintain due to a number of issues, including accessibility of the solar panels and the availability of personnel to clean the solar panels.

Accordingly, there exists a need in the art for automatically cleaning solar panels, and in particular, a need for automatically cleaning solar panels based on accumulated soil levels.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, an automatic solar panel cleaning (“ASC”) system includes a solar panel, a sensor, a tank, a pump, a nozzle, and a controller. The solar panel includes a face and a frame. The sensor includes a light source and a receiver, the light source being configured to emit a light at the face, and the receiver being configured to output a signal based on an amount of the light detected by the receiver, the amount of light detected being correlated to an amount of soil accumulation on the face of the solar panel. The tank stores a cleaning fluid. The pump is in fluid communication with the tank. The nozzle is located adjacent to a first end of the solar panel and in fluid communication with the tank and the pump, the nozzle being oriented such that the cleaning fluid exiting the nozzle is directed at the face of the solar panel. The controller includes a computer-readable medium having instructions stored thereon, that when executed, cause a cleaning operation to be performed. The cleaning operation comprising comparing the signal that is output by the receiver to an accumulation threshold, the accumulation threshold being indicative of an undesired soil accumulation on the face of the solar panel. The cleaning operation further comprises starting and running the pump after the signal reaches the accumulation threshold, thereby pumping the cleaning fluid from the tank and out of the nozzle onto the face of the solar panel.

According to an embodiment consistent with the present disclosure, a method of cleaning a solar panel comprises comparing a signal output of a sensor coupled to a solar panel to an accumulation threshold, the accumulation threshold being indicative of an accumulation of soil on a face of the solar panel; starting a pump in fluid communication with a tank of cleaning fluid and at least one nozzle after the signal output reaches the accumulation threshold; and running the pump to spray the cleaning fluid out of one or more nozzles onto the face of the solar panel.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a perspective view of an example automatic solar panel cleaning system (“ASC”) that incorporates the principles of the present disclosure.

FIG. 2A is a schematic cross-sectional view of a solar panel showing a sensor monitoring an area of a face of the solar panel.

FIG. 2B is a schematic cross-sectional view of the solar panel of FIG. 2A, showing the effect of soil accumulation on light detected by a receiver of the sensor.

FIG. 3 is a graphical view of a voltage output of a sensor compared to a first voltage threshold and a second voltage threshold.

FIG. 4 is a schematic flow chart illustrating an example method of an automatic solar panel cleaning operation.

FIG. 5 is a block diagram of a nonlimiting example computer system that can be employed to execute one or more elements of the procedures described herein in accordance with embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to automated solar panel cleaning and, more particularly, to automatically cleaning solar panels in response to a detected soil level on the face of a solar panel. More specifically, one or more sensors may be used to monitor soil accumulation on a solar panel, and the solar panel may be automatically cleaned once the sensors detect an unacceptable level of soil accumulation. Additionally, the sensors may monitor the cleanliness of the solar panel during a cleaning operation, which may be stopped when the sensors detect that all or substantially all the soil accumulation has been removed.

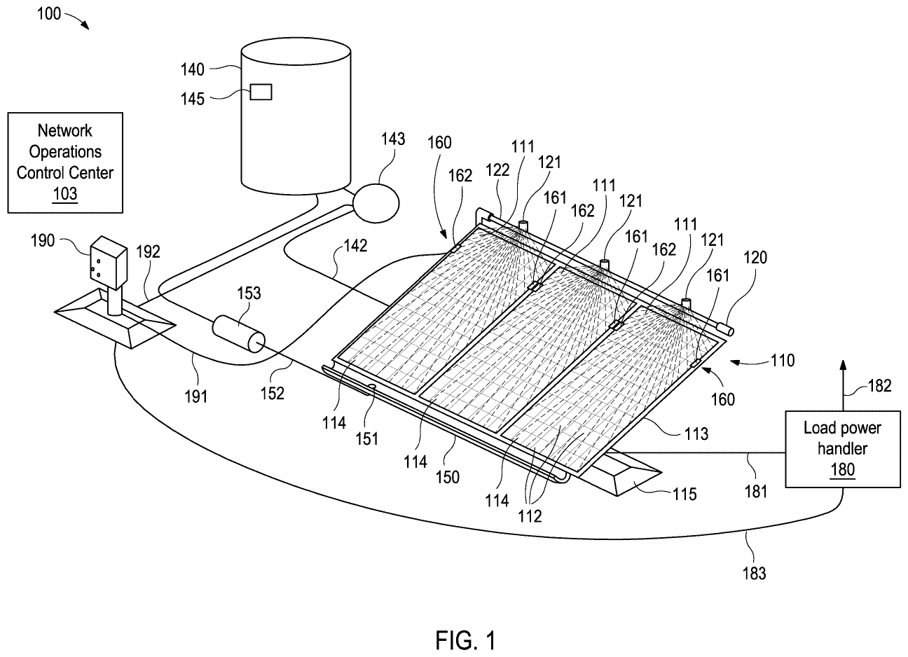

FIG. 1 is a perspective view of an example automatic solar panel cleaning (“ASC”) system 100, according to embodiments of the present disclosure. The ASC system 100 includes at least one solar panel array 110, a cleaning array 120, a tank 140, at least one sensor 160, a load power handler 180, and a controller 190 (e.g., computer system). The ASC system 100 can be part of a solar power generating system (e.g., solar farm). The ASC system 100 may be located in a remote location, such as being located in a desert. The ACS system 100 may used in either onshore or offshore applications, such as being integrated into an oil rig.

The solar panel array 110 includes at least one solar panel 111 (three shown). Each solar panel 111 includes a plurality of photovoltaic (“PV”) modules 112 (e.g., solar cells) that produce electrical power in response to sunlight exposure. The PV modules 112 are supported by a frame 113, which extends around the edge or perimeter of the solar panel 111. Each solar panel 111 may be supported on a base 115, and may be oriented at an angle (e.g., tilted) relative to the base 115, as shown in FIG. 1, to orient the solar panels 111 toward the sun. While only one solar panel array 110 is shown, the ASC system 100 may have a plurality of solar panel arrays 110.

The electrical power generated by the solar panel array 110 is supplied to the load power handler 180 by an electrical load line 181 connected to the PV modules 112 of the solar panels 111. The load power handler 180 is operable to send the generated electrical power to a regional power grid or other electrical network connected to the load power handler 180, as indicated by electrical line 182. Some of the electrical power generated by the solar panel array 110 may be utilized by the ASC system 100 itself, such as being used to supply electricity to one or more components of the ASC system 100. For example, the controller 190 may receive electrical power from the load power handler 180 via electric supply line 183. In some embodiments, one or more components of the ASC system 100 include a battery that can be recharged by receiving electrical power from the load handler 180.

Particulate matter in the environment, such as dust, may settle on a face 114 (e.g., upper surface facing the sun) of the solar panels 111. The soil (e.g., dust, particulate matter, and/or other deposits) that builds up on a solar panel 111 will eventually cause a reduction in the efficiency of the solar panel 111 since the soil blocks some of the sunlight from reaching the PV module 112. In some cases, the efficiency of the solar panels 111 may drop 50% over the course of a month of operation due to the accumulated soil. Enough soil may build up that completely blocks sunlight from interacting with one or more of the PV modules 112.

One or more of the solar panels 111 includes at least one sensor 160 operable to monitor soil accumulation. The sensors 160 are in communication with the controller 190, which uses the information obtained from the sensors 160 to determine if one or more of the solar panels 111 in the array of solar panels 111 needs to be cleaned. The controller 190 can then initiate a cleaning operation using the cleaning array 120 based on the information obtained from the sensos 160. In some embodiments, the controller 190 initiates the cleaning operation automatically without human intervention, which is advantageous in remote applications of the ASC system 100.

Each sensor 160 monitors one area of the associated solar panel 111. The sensor 160 includes a light source 161 and a receiver 162. In some embodiments, the light source 161 is a laser emitter that directs a laser beam at the face 114 of the solar panel 111. The light source 161 and receiver 162 are disposed on opposite sides of the solar panel 111. The light source 161 and receiver 162 are connected to (e.g., mounted to) the frame 113. The light source 161 emits electromagnetic radiation (e.g., light) that is aimed at the face 114 of the solar panel 111. Some of this light reflects off the face 114 and is detected by the receiver 162. Soil that has accumulated on the solar panel 111 absorbs some of the light emitted by the light source 161, and the amount of light detected by the receiver 162 decreases as the depth (amount) of the soil on the face 114 increases. The amount of light detected by the receiver 162 can be correlated with the depth of soil (e.g., level) that has accumulated on the face 114 of the solar panel 111. In some embodiments, the receiver 162 outputs a voltage signal based on the amount of light detected. The voltage of the voltage signal can be correlated with the depth of the soil.

The controller 190 may be configured or otherwise programmed to compare the amount of light detected by the receiver 162 to a stored accumulation threshold. This accumulation threshold is a predetermined unacceptable level of accumulation of soil on the solar panel 111. In some embodiments, the accumulation threshold is a voltage threshold that is compared to the voltage output by the sensor 160. The accumulation threshold may be selected based on the desired minimum efficiency of the solar panel 111 before initiating a cleaning operation. For example, the accumulation threshold may be based on the soil accumulation that would cause an undesired drop in the solar panel efficiency. The accumulation threshold may be the amount of light indicative of a soil accumulation that would decrease the solar panel efficiency by about 10%, and in other embodiments by about 20%, 30%, 40%, or 50%.

In some embodiments, only one solar panel 111 of the ASC system 100 has a sensor 160. In these embodiments, the controller 190 may initiate cleaning the entire solar array 110 based on the detected soil level on the one solar panel 111 that includes the sensor 160. In some other embodiments, each solar panel 111 of the ASC system 100 includes at least one sensor 160. This allows the controller 190 to selectively clean one or more of the solar panels 111 in the solar panel array 110 based on the information obtained from the relevant sensors 160. In some embodiments, the controller 190 may initiate cleaning all the solar panels 111 in the solar panel array 110 when the controller 190 determines that a number (e.g., more than two) of the solar panels 111 has unacceptable accumulations of soil.

In some embodiments, one or more of the solar panels 111, such as all of the solar panels 111, include multiple sensors 160 to monitor multiple areas on the face 114. For example, the solar panel 111 may have more than three sensors 160 arranged along the length of the frame 113. Multiple sensors 160 allow the controller 190 to evaluate the soil accumulation on different parts of the solar panel 111. For example, one area of the face 114 of the solar panel 111 may have an unacceptable soil accumulation while other areas of the face 114 of the solar panel 111 have soil accumulations within the acceptable accumulation threshold. The controller 190, therefore, may wait to initiate a cleaning operation until multiple areas of the solar panel 111 have an unacceptable soil level. For example, the controller 190 may not initiate a cleaning operation until between 25% to 30% of the sensors 160 connected to a solar panel 111 detect an unacceptable soil level. Additionally, the percentage of sensors 160 detecting an unacceptable soil level needed to cause the controller 190 to initiate the cleaning operation may vary based on the season. For example, the controller 190 may initiate a cleaning operation during the summer when around 25% of the sensors 160 detect unacceptable soil levels and may initiate the cleaning operation during the winter when around 30% of the sensors 160 detect unacceptable soil levels.

In some embodiments, the controller 190 uses the sensors 160 for real time monitoring of the soil levels on the solar panels 111. In other embodiments, the sensors 160 sample the soil levels over a desired sample frequency, such as taking measurement every hour, every day, every week, etc. The sensors 160 allow the controller 190 to monitor the soil level on one or more of the solar panels 111 during the day and night. As an example, a dust storm may pass in the night and cover the solar panels 111. Once the sensors 160 have detected an unacceptable soil accumulation, the controller 190 can initiate a cleaning operation to clean the solar panels 111 before sunrise.

In some embodiments, the controller 190 is connected to the sensors 160 via a first control line 191, and the information obtained by the sensors 160 is sent to the controller 190 via the first control line 191. The first control line 191 may also supply electrical power received from the supply line 183 to the sensors 160. The first control line 191 may also be in communication with the cleaning array 120, allowing the controller 190 to send control signals and electrical power to the cleaning array 120 via the first control line 191.

The cleaning array 120 is coupled to each solar panel array 110, and includes a plurality of nozzles 121 arranged along a conduit 122 adjacent to the upper end of the solar panels 111. The nozzles 121 are operable to spray a cleaning fluid (e.g., water) at one or more of the solar panels 111. Each nozzle 121 is oriented such that a cleaning fluid exiting the nozzle 121 is directed at one or more of the solar panels 111. The cleaning fluid flows along the face 114 under the influence of gravity and drips off the lower end of the solar panel 111. The cleaning fluid removes (e.g., washes) soil that has accumulated on the face 114 of the solar panel 111 as the cleaning fluid flows along the face 114. As shown in FIG. 1, the cleaning array 120 has a nozzle 121 for each of the individual solar panels 111. In some embodiments, the cleaning array 120 may have a plurality of nozzles 121 for each solar panel 111, such as having two or three nozzles 121 positioned along the width of the solar panel 111.

The tank 140 stores the cleaning fluid, which is supplied to the cleaning array 120 from the tank 140 via a supply conduit 142. In some embodiments, a pump 143 is used to pump the cleaning fluid through the supply conduit 142 from the tank 140 to the cleaning array 120 where the cleaning fluid is sprayed onto the solar panels 111 via the nozzles 121.

In some embodiments, the dirty cleaning fluid dripping off the lower end of the solar panels 111 can be recycled to conserve the cleaning fluid. In such embodiments, the ASC system 100 may include a gutter 150 positioned at or under the lower end of the solar panels 111 to receive the dirty cleaning fluid dripping off the solar panels 111. The dirty cleaning fluid exits the gutter 150 via a drain 151 where the fluid enters a return conduit 152 in communication with the tank 140 and a filter 153. The dirty cleaning fluid flows through the filter 153 which removes a portion of the soil from the cleaning fluid. In some embodiments, the filter 153 may remove substantially all of the soil from the cleaning fluid. The filter 153 may be a sand filter, charcoal filter, or other suitable filter. The cleaning fluid exiting the filter 153 flows back into the tank 140. In some embodiments, a pump (not shown) may be used to pump the fluid within the return conduit 152 through the filter 153 and back into the tank 140.

When initiating a cleaning operation, the controller 190 causes the pump 143 to supply the cleaning fluid to the cleaning array 120. The controller 190 may also selectively open or close one or more valves (not shown) of the cleaning array 120 to open and close a nozzle 121. For example, a valve may be opened to allow the cleaning fluid supplied by the pump 143 to flow out of a nozzle 121 and the valve may be closed to stop fluid from flowing out of the nozzle 121. The controller 190 may send instructions to the pump 143 via a second control line 192, which may also supply electrical power received from the supply line 183 to power the pump 143.

In some embodiments, the sensors 160 monitor the soil level during the cleaning operation. The controller 190 may end the cleaning operation once one or more of the sensors 160 have detected that the solar panels 111 are clean, such as when the amount of light detected by the receiver 162 is indicative of minimal soil being present on the face 114 of the solar panel 111. In other embodiments, the controller 190 instead operates the pump 143 based on a timer and stops the cleaning operation after a set (predetermined) period of time.

In some embodiments, the controller 190 monitors the amount of cleaning fluid present in the tank 140 using a fluid level sensor 145, such as a float sensor. The controller 190 may end a cleaning operation before the cleaning fluid is exhausted. The controller 190 may also initiate an alert to a network operations control (“NOC”) center 103 if the fluid level drops below a predetermined fluid level threshold, such as reaching a level capable of completing only a predetermined number (e.g., three) more cleaning operations. The NOC center 103 can dispatch personnel to refill the tank 140 in response to the alert. The NOC center 103 is remote to the ASC system 100, such as being tens or hundreds of kilometers away from the ASC system 100.

In some embodiments, the sensors 160 can be used in solar panel systems that do not have the equipment necessary to perform an automatic cleaning operation. Instead, the sensors 160 are used to monitor soil accumulation on the solar panels 111 and the controller 190 alerts the NOC center 103 if the accumulation exceeds the unacceptable accumulation threshold. The NOC center 103 can then dispatch a cleaning crew to remove the soil accumulations. In embodiments with multiple sensors 160 on a solar panel 111, the cleaning crew can be directed to specific location(s) on one or more solar panels 111 that need cleaning to facilitate efficient cleaning of the solar panels 111.

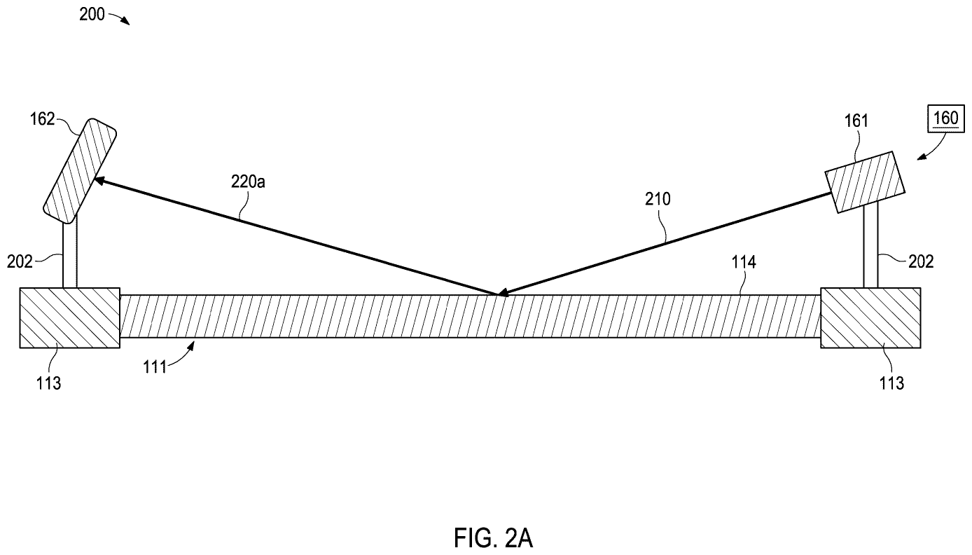

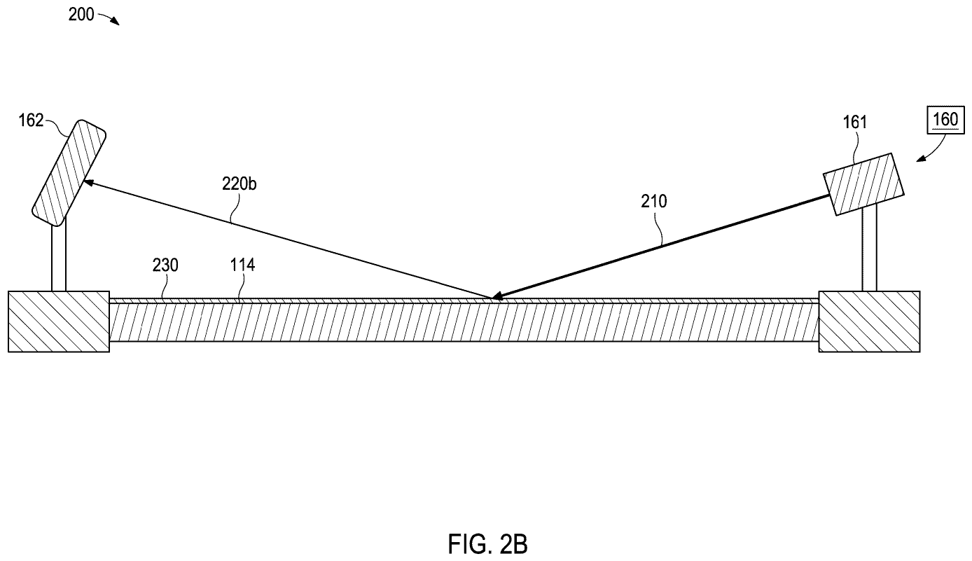

FIGS. 2A-2B illustrate a schematic cross-sectional view of a portion 200 of a solar panel 111 along the width of the solar panel 111 to show example operation of the sensor 160. Referring first to FIG. 2A, the light source 161 and the receiver 162 are located on opposing sides of the solar panel 111. The light source 161 and the receiver 162 are fixed to the frame 113 and positioned above the face 114 by a separate mount 202.

As mentioned above, the light source 161 may comprise a laser emitter operable to emit a laser beam 210. The laser beam 210 is directed at an angle to an area on the face 114 of the solar panel 111, which is depicted in FIG. 2A as being currently clean with little to no soil accumulation. Some of the laser beam 210 is reflected toward the receiver 162, as indicated by arrow 220a (referred to as “first reflected light”). The first reflected light 220a detected by the receiver 162 causes the receiver 162 to output a voltage signal that is received by the controller 190 (FIG. 1). The controller 190 then compares the voltage signal to a voltage threshold (e.g., accumulation threshold) that is indicative of an unacceptable amount of soil accumulation on the face 114.

FIG. 2B illustrates the solar panel 111 after soil 230 has accumulated on the face 114. The soil 230 absorbs some of the laser beam 210 emitted by the light source 161 which decreases the amount of reflected light detected by the receiver 162. The reflected light is shown as arrow 220b (herein referred to as “second reflected light”). Due to the accumulation of soil 230, the second reflected light 220b has a decreased magnitude as compared to the first reflected light 220a, as shown schematically by the difference in the relative thickness of arrows 220a,b. The controller 190 monitors the detected light level, such as the voltage output, detected by the receiver 162. The controller 190 compares the detected light level to the accumulation threshold. In response to the accumulation threshold being reached or exceeded, the controller 190 may then be configured to initiate an automatic cleaning operation by starting the pump 143 to clean the solar panel 111, or the controller 190 may alternatively be programmed to send an alert to the NOC center 103 (FIG. 1) to send a cleaning crew to clean the solar panel 111.

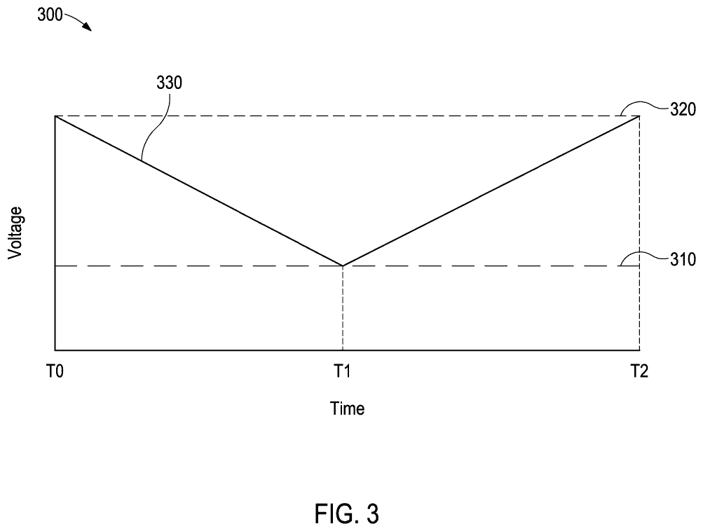

FIG. 3 is a graph showing a voltage output 330 of the receiver 162 over time compared to a first voltage threshold 310 and a second voltage threshold 320. As shown, the voltage output 330 decreases between initial time T0 and first time T1 as soil accumulates on the face 114 of the solar panel 111 (FIG. 1). In some embodiments, and as shown in FIG. 3, the decrease in the voltage output 330 between T0 and T1 may be substantially linear due to steady accumulation of soil onto the solar panel 111. In other embodiments, the voltage output 330 may be non-linear, such as fluctuating over time due to a fluctuating soil level. For example, the soil level may fluctuate as wind adds and removes soil, precipitation washes some or all of the soil off of the solar panel 111, or during a cleaning operation as cleaning fluid washes the soil off the solar panel 111. The controller 190 compares the voltage output 330 to the first voltage threshold 310 (e.g., accumulation threshold), which is representative of an undesired depth of soil accumulation on the solar panel 111. The controller 190 may initiate an automatic cleaning operation after the voltage output 330 decreases to reach or drop below the first voltage threshold 310. The controller 190 may operate the pump 143 to spray cleaning fluid out of the nozzles 121 to clean the solar panels 111 until a second voltage threshold 320 (e.g., clean threshold) is reached or exceeded (e.g., voltage is greater than the second voltage threshold 320). The second voltage threshold 320 is indicative of a substantially clean solar panel 111 with little to no soil remaining on the area being monitored by the sensor 160. The controller 190 may turn off the pump 143 after the second voltage threshold 320 is reached.

For example, FIG. 3 illustrates that the voltage output 330 reaches the first voltage threshold 330 at time T1. The controller 190 then automatically initiates a cleaning operation by turning on the pump 143 to supply cleaning fluid to the cleaning array 120. The voltage output 330 steadily increases after time T1 as the soil is washed away by the cleaning fluid. The controller 190 turns off the pump 143 to automatically stop the cleaning operation once the voltage output 330 reaches the second voltage threshold 320 at time T2.

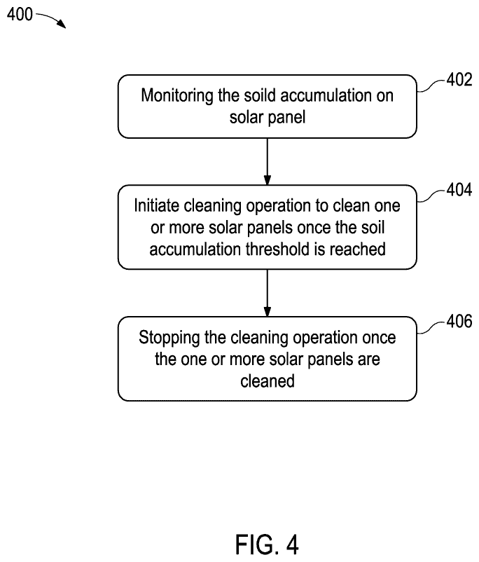

FIG. 4 is a schematic flow chart illustrating an example method 400 of an automatic solar panel cleaning operation. At operation 402, the soil accumulation on one or more solar panels 111 is monitored by one or more sensors 160. The controller 190 compares the output of one or more sensors 160 to the accumulation threshold. For example, the controller 190 may be monitoring the voltage output of each sensor 160 and comparing the voltage output to the first voltage threshold 310.

At operation 404, the controller 190 initiates a cleaning operation to clean one or more of the solar panels 111 after the soil accumulation threshold is reached. The controller 190 initiates a cleaning operation by causing the pump 143 to pump cleaning fluid from the tank 140 out of one or more of the nozzles 121. More specifically, the controller 190 starts the pump 143 after the accumulation threshold is reached and then runs the pump 143 to spray the cleaning fluid out of the one or more nozzles. In some embodiments of operation 404, the controller 190 selectively opens one or more nozzles 121 to clean only the solar panels 111 with unacceptable soil accumulations detected by a sensor 160. In other embodiments, the controller 190 cleans all the solar panels 111 when one or more of the solar panels 111 have an unacceptable soil accumulation. The controller 190 may send an alert to the NOC center 103 center once the cleaning operation is initiated.

In some embodiments of operation 404, the controller 190 may initiate a cleaning operation to clean the solar panels at operation 404 once a predetermined number of the sensors 160 have detected a soil accumulation that exceeds the accumulation threshold. For example, the controller 190 may initiate the cleaning operation when two or more of the solar panels 111 in the solar panel array 110 have soil accumulations that reach or exceed the accumulation threshold. In some embodiments, the controller 190 may initiate the cleaning operation when the output of any of the sensors 160 reaches or exceeds the accumulation threshold.

At operation 406, the controller 190 stops the cleaning operation after the one or one or more solar panels 111 are cleaned. For example, the controller 190 may monitor the output of the sensors 160 during the cleaning operation to determine when the solar panels 111 have reached a desired cleanliness, such as monitoring for the output to reach a clean threshold. This clean threshold may be the second voltage threshold 320. In some embodiments, the controller 190 stops the cleaning operation once all the solar panels 111 being cleaned have reached the clean threshold. In other embodiments, the controller 190 may close a nozzle 121 once a solar panel 111 has reached the clean threshold. In other words, the controller 190 can selectively stop cleaning one solar panel 111 while cleaning another solar panel 111. The controller 190 may send an alert to the NOC center 103 once the cleaning operation is stopped.

Method 400 may repeat after the solar panels 111 are cleaned such that a cleaning operation may once again be initiated when the solar panels 111 are covered again in an unacceptable amount of soil.

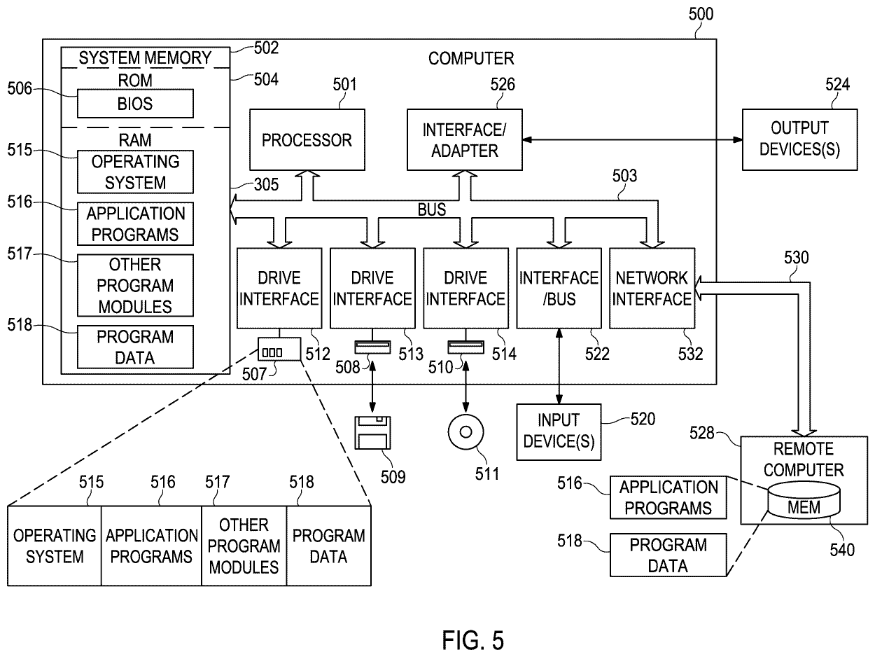

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-usable storage medium having computer-readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 5 illustrates one example of a computer system 500 that can be employed to execute one or more embodiments of the present disclosure. The controller 190 may be the computer system 500. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 502, system memory 504, and system bus 506 that couples various system components, including the system memory 504, to processing unit 502. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 510 and random access memory (RAM) 512. A basic input/output system (BIOS) 514 can reside in ROM 510 containing the basic routines that help to transfer information among elements within computer system 500.

Computer system 500 can include a hard disk drive 516, magnetic disk drive 518, e.g., to read from or write to removable disk 520, and an optical disk drive 522, e.g., for reading CD-ROM disk 524 or to read from or write to other optical media. Hard disk drive 516, magnetic disk drive 518, and optical disk drive 522 are connected to system bus 506 by a hard disk drive interface 526, a magnetic disk drive interface 528, and an optical drive interface 530, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 510, including operating system 532, one or more application programs 534, other program modules 536, and program data 538. In some examples, the application programs 534 can include the thresholds for initiating and stopping a cleaning operation and capability to operate the pump 143, and the program data 538 can include inputs received from the sensors 160, such as the voltage output. The application programs 534 and program data 538 can include functions and methods programmed to monitor the soil level on the solar panels and to initiate and stop a cleaning operation based on the soil level of the solar panels, such as shown and described herein.

A user may enter commands and information into computer system 500 through one or more input devices 540, such as a pointing device (e.g., a mouse, touch screen), keyboard, microphone, joystick, game pad, scanner, and the like. For instance, the user can employ input device 540 to edit or modify the thresholds or the amount of time that the pump 143 is operated during a cleaning operation. These and other input devices 540 are often connected to processing unit 502 through a corresponding port interface 542 that is coupled to the system bus, but may be connected by other interfaces, such as a parallel port, serial port, or universal serial bus (USB). One or more output devices 544 (e.g., display, a monitor, printer, projector, or other type of displaying device) is also connected to system bus 506 via interface 546, such as a video adapter.

Computer system 500 may operate in a networked environment using logical connections to one or more remote computers, such as remote computer 548. Remote computer 548 may be a workstation, computer system, router, peer device, or other common network node, and typically includes many or all the elements described relative to computer system 500. The logical connections, schematically indicated at 550, can include a local area network (LAN) and a wide area network (WAN). When used in a LAN networking environment, computer system 500 can be connected to the local network through a network interface or adapter 552. When used in a WAN networking environment, computer system 500 can include a modem, or can be connected to a communications server on the LAN. The modem, which may be internal or external, can be connected to system bus 506 via an appropriate port interface. In a networked environment, application programs 534 or program data 538 depicted relative to computer system 300, or portions thereof, may be stored in a remote memory storage device 554.

Embodiments disclosed herein include:
A. An automatic solar panel cleaning (“ASC”) system includes a solar panel, a sensor, a tank, a pump, a nozzle, and a controller. The solar panel includes a face and a frame. The sensor includes a light source and a receiver, the light source being configured to emit a light at the face, and the receiver being configured to output a signal based on an amount of the light detected by the receiver, the amount of light detected being correlated to an amount of soil accumulation on the face of the solar panel. The tank stores a cleaning fluid. The pump is in fluid communication with the tank. The nozzle is located adjacent to a first end of the solar panel and in fluid communication with the tank and the pump, the nozzle being oriented such that the cleaning fluid exiting the nozzle is directed at the face of the solar panel. The controller includes a computer-readable medium having instructions stored thereon, that when executed, cause a cleaning operation to be performed. The cleaning operation comprising comparing the signal that is output by the receiver to an accumulation threshold, the accumulation threshold being indicative of an undesired soil accumulation on the face of the solar panel. The cleaning operation further comprises starting and running the pump after the signal reaches the accumulation threshold, thereby pumping the cleaning fluid from the tank and out of the nozzle onto the face of the solar panel.
B. A method of cleaning a solar panel comprises comparing a signal output of a sensor coupled to a solar panel to an accumulation threshold, the accumulation threshold being indicative of an accumulation of soil on a face of the solar panel; starting a pump in fluid communication with a tank of cleaning fluid and at least one nozzle after the signal output reaches the accumulation threshold; and running the pump to spray the cleaning fluid out of one or more nozzles onto the face of the solar panel.

Each of embodiments A and B may have one or more of the following additional elements in any combination:

Element 1: the light source is a laser emitter and the light is a laser beam. Element 2: the cleaning operation further comprises: comparing the signal that is output by the receiver while the pump is running to a clean threshold, the clean threshold being indicative of the face being cleaned to an acceptable level; and stopping the pump after the clean threshold is reached. Element 3: the signal is a voltage signal, the accumulation threshold is a first voltage threshold, and the clean threshold is a second voltage threshold. Element 4: further comprising: a gutter located adjacent to a second end of the solar panel that is opposite of the first end to receive cleaning fluid flowing off the face of the solar panel; and a filter in fluid communication with the gutter and the tank, wherein cleaning fluid flowing from the gutter flows through the filter. Element 5: further comprising: a load power handler configured to transmit a first portion of electrical power generated by the solar panel to a power grid and to transmit a second portion of the electrical power generated by the solar panel to the controller. Element 6: the sensor is one of a plurality of sensors, and wherein starting and running the pump after the signal reaches the accumulation threshold further comprises starting and running the pump after more than one of the plurality of sensors output the signal that reaches the accumulation threshold. Element 7: the tank further comprises a fluid level sensor configured to detect an amount of cleaning fluid stored in the tank, the fluid level sensor being in communication with the controller. Element 8: the controller is configured to send an alert to a network operations center when the amount of cleaning fluid stored in the tank detected by the fluid level sensor reaches a fluid level threshold. Element 9: further comprising: comparing the signal output of the sensor to a clean threshold while running the pump, wherein the clean threshold is indicative of the face being cleaned of the soil accumulation to a predetermined level; and stopping the pump after the clean threshold is reached. Element 10: further comprising sending an alert to a network operations control center after stopping the pump. Element 11: further comprising stopping the pump after a set period of time. Element 12: further comprising sending an alert to a network operations control center after starting the pump. Element 13: the sensor includes a light source and a receiver, wherein the signal output is the amount of light detected by the receiver.

By way of non-limiting example, exemplary combinations applicable to A and B include: Element 2 with Element 3; Element 9 with Element 10.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. An automatic solar panel cleaning (“ASC”) system, comprising:
a solar panel including a face and a frame;
a sensor including a light source and a receiver, the light source being configured to emit a light at the face, and the receiver being configured to output a signal based on an amount of the light detected by the receiver, the amount of light detected being correlated to an amount of soil accumulation on the face of the solar panel;
a tank storing a cleaning fluid;
a pump in fluid communication with the tank;
a nozzle located adjacent to a first end of the solar panel and in fluid communication with the tank and the pump, the nozzle being oriented such that the cleaning fluid exiting the nozzle is directed at the face of the solar panel;
a controller including a computer-readable medium having instructions stored thereon, that when executed, cause a cleaning operation to be performed, the cleaning operation comprising:
comparing the signal output by the receiver to an accumulation threshold indicative of an undesired soil accumulation on the face of the solar panel; and
operating the pump after the signal reaches the accumulation threshold, thereby pumping the cleaning fluid from the tank and out of the nozzle onto the face of the solar panel.

2. The ASC system of claim 1, wherein the light source is a laser emitter and the light is a laser beam.

3. The ASC system of claim 1, wherein the cleaning operation further comprises:
comparing the signal output by the receiver to a clean threshold while the pump is running, the clean threshold being indicative of the face being cleaned to an acceptable level; and
stopping the pump after the clean threshold is reached.

4. The ASC system of claim 3, wherein the signal is a voltage signal, the accumulation threshold is a first voltage threshold, and the clean threshold is a second voltage threshold.

5. The ASC system of claim 1, further comprising:
a gutter located adjacent to a second end of the solar panel opposite of the first end and operable to receive cleaning fluid flowing off the face of the solar panel; and
a filter in fluid communication with the gutter and the tank, wherein cleaning fluid flowing from the gutter flows through the filter.

6. The ASC system of claim 1, further comprising a load power handler configured to transmit a first portion of electrical power generated by the solar panel to a power grid and to transmit a second portion of the electrical power generated by the solar panel to the controller.

7. The ASC system of claim 1, wherein the sensor is one of a plurality of sensors, and wherein operating the pump after the signal reaches the accumulation threshold further comprises starting and running the pump after more than one of the plurality of sensors output the signal that reaches the accumulation threshold.

8. The ASC system of claim 1, wherein the tank further comprises a fluid level sensor configured to detect an amount of cleaning fluid stored in the tank, the fluid level sensor being in communication with the controller.

9. The ASC system of claim 8, wherein the controller is configured to send an alert to a network operations center when the amount of cleaning fluid stored in the tank detected by the fluid level sensor reaches a fluid level threshold.

10. A method of cleaning a solar panel, comprising:
comparing a signal output of a sensor coupled to a solar panel to an accumulation threshold indicative of an accumulation of soil on a face of the solar panel;
starting a pump in fluid communication with a tank of cleaning fluid and at least one nozzle after the signal output reaches the accumulation threshold; and
running the pump to spray the cleaning fluid out of one or more nozzles onto the face of the solar panel.

11. The method of claim 10, further comprising:
comparing the signal output of the sensor to a clean threshold while running the pump, wherein the clean threshold is indicative of the face being cleaned of the soil accumulation to a predetermined level; and
stopping the pump after the clean threshold is reached.

12. The method of claim 11, further comprising sending an alert to a network operations control center after stopping the pump.

13. The method of claim 10, further comprising stopping the pump after a set period of time.

14. The method of claim 10, further comprising sending an alert to a network operations control center after starting the pump.

15. The method of claim 10, wherein the sensor includes a light source and a receiver, wherein the signal output is the amount of light detected by the receiver.
